(19) United States
(12) Patent Application Publication
(10) Pub. No.: US 2010/0168963 A1
(43) Pub. Date: Jul. 1, 2010

(54) CONTROL SYSTEM FOR ELECTRONIC POWER STEERING

(75) Inventor: Satoshi Yamamoto, Maebashi-shi (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 12/299,998

(22) PCT Filed: Apr. 24, 2007
(86) PCT No.: PCT/JP2007/058875

§ 371 Date: Nov. 7, 2008

(30) Foreign Application Priority Data
May 8, 2006 (JP) 2006-129331

(51) Int. Cl. B62D 6/00; B62D 5/04

(52) U.S. Cl. 701/42

(57) ABSTRACT

There is provided a control system for an electronic power steering. The control system includes: a SAT estimating portion for estimating a self aligning torque (SAT) of a vehicle by inputting an angular velocity and an angular acceleration of a motor, a steering torque, and a current command value; and a motor current correction value calculating portion for deciding a running state of the vehicle based on a SAT estimation value estimated by the SAT estimating portion, a vehicle speed, and a steering angle, and correcting the current command value by calculating a motor current correction value based on the SAT estimation value in accordance with the running state. According to this configuration, an offset torque can be always corrected precisely irrespective of a road surface situation or a driving condition such as a straight line running, and thus a comfortable steering performance can be attained by lessening driver's fatigue.

### TECHNICAL FIELD

The present invention relates to a control system for an electronic power steering for applying a steering assisting force to a steering system of a vehicle by driving a motor and, more particularly, to a control system for a high-performance electronic power steering that is equipped with a function of correcting an offset torque.

### BACKGROUND ART

The electronic power steering applies an assist load to (assists) the steering unit of the vehicle by a turning force of a motor. This electronic power steering transfers a driving force of the motor as the assist load to a steering shaft or a rack shaft through a transfer mechanism such as a gear, a belt, or the like via a reduction gear. In order to generate an assist torque (steering assisting force) precisely, such electronic power steering in the prior art employs a feedback control of a motor current. The feedback control controls a voltage applied to the motor such that a difference between a current command value and a current detected value of the motor is reduced. Normally the voltage applied to the motor is controlled by adjusting a duty ratio in Pulse-Width Modulation (PWM) control.

Here, a common configuration of the electronic power steering is explained with reference to FIG. 12 hereunder. A column shaft 2 of a steering wheel 1 is coupled to tie-rods 6 of steered wheels via a reduction gear 3, universal joints 4A and 4B, and a rack & pinion mechanism 5. A torque sensor 10 for detecting a steering torque of the steering wheel 1 is provided to the column shaft 2. A motor 20 used to assist a steering force of the steering wheel 1 is coupled to the column shaft 2 via the reduction gear 3. An electric power is supplied from a battery 14 to a control unit 30 that controls the steering unit, and also an ignition signal is input from an ignition key 11 to the control unit 30. The control unit 30 calculates a steering assist command value I of the assist command based on a steering torque T detected by the torque sensor 10 and a vehicle speed V detected by a vehicle speed sensor 12 by using an assist map, or the like, and then controls a current supplied to the motor 20 based on the calculated steering assist command value I.

The control unit 30 is composed mainly of CPU (or MPU or MCU). Common functions executed by a program in the inside of CPU are given as shown in FIG. 13.

Functions and operations of the control unit 30 will be explained with reference to FIG. 13 hereunder. The steering torque T detected/input by the torque sensor 10 and the vehicle speed V detected/input by the vehicle speed sensor 12 are input into a steering assist command value calculating portion 31, and then a basic steering assist command value Iref1 is calculated. The basic steering assist command value Iref1 calculated by the steering assist command value calculating portion 31 is subjected to the phase compensation by a phase compensating portion 32 so as to enhance a stability of the steering system. Then, a steering assist command value Iref2 whose phase is compensated is input into an adding portion 33. Also, the steering torque T is input into a differentiation compensating portion 35 of a feed forward system to increase a response speed, and a steering torque TA that is subjected to the differentiation compensation is input into the adding portion 33. The adding portion 33 adds the steering assist command value Iref2 and the steering torque TA, and inputs a current command value Iref3 (=Iref2+TA) as the added result into a subtracting portion 34 for the feedback use.

The subtracting portion 34 calculates a deviation (Iref3−i) between the current command value Iref3 and a motor current i that is being fed back as a current command value Iref4. The current command value Iref4 is PI-controlled by a PI controlling portion 36, and is input into a PWM controlling portion 37 where a duty ratio is calculated, and then the motor 20 is PWM-driven via an inverter 38. The motor current of the motor 20 is detected by a motor current detecting portion (not shown), then is input into the subtracting portion 34 to be used for subtracting, and then is fed back.

In such electronic power steering, such a situation must be prevented that, when the torque sensor detects a vibration applied from the vehicle body side, a vibration generated by an engine, or the like, for example, the steering operation becomes unstable. For this purpose, in JP-A-2001-39324 (Patent Literature 1), for example, there is provided a gain limiting means for executing a process in which a gain of a differentiating means that compensates the steering torque by a derivation is set to 0 when an output voltage value of the torque sensor is smaller than a threshold value.

Patent Literature 1: JP-A-2001-39324

### DISCLOSURE OF THE INVENTION

### Problems that the Invention is to Solve

However, in the system set forth in Patent Literature 1, the steering torque being input from the road surface such as inclined road surface that is inclined in the road width direction, road surface whose coefficient of friction is different between the left and right wheels, so-called split-μ road surface, or the like during the running or the input torque being generated when an air pressure in the tire is different between left and right wheels is applied to the steering system. In this situation, when this torque is detected by the torque sensor, a differential gain is set to 0 and as a result such an event can be prevented that the assisting force is changed unsteadily. However, a constant torque input that is transferred continuously to the steering system from the road surface or the vehicle body side cannot be cancelled.

The present invention has been made in view of above circumstances, and it is an object of the present invention to provide a control system for an electronic power steering, capable of lessening driver's fatigue and attaining a comfortable steering performance by always correcting precisely an offset torque irrespective of a road surface situation or a driving condition such as a straight line running, or the like.

### Means for Solving the Problems

The above object of the present invention can be achieved by following configurations.

(1) In a control system for an electronic power steering that drives and controls a motor by feedback control, the control system includes:

a steering assist command value calculating portion for calculating and outputting a current command value of the motor, which applies a steering assisting force to a steering mechanism, based on a steering torque and a vehicle speed;

a SAT estimating portion for estimating a SAT of a vehicle by inputting an angular velocity and an angular acceleration of the motor, the steering torque, and the current command value; and

a motor current correction value calculating portion for deciding a running state of the vehicle based on a SAT estimation value estimated by the SAT estimating portion, the vehicle speed, and a steering angle, and correcting the current command value by calculating a motor current correction value based on the SAT estimation value in accordance with the running state.

(2) In the control system according to (1), the motor current correction value calculating portion is configured to: decide a steering state by deciding a straight running state; and calculate the motor current correction value after a predetermined time elapsed in a case where the steering angle is equal to or less than a predetermined value 1, an absolute value of the SAT estimation value is equal to or less than a predetermined value 2, and the vehicle speed is equal to or more than a predetermined value 3.

(3) In the control system according to (1), the motor current correction value calculating portion is configured to: decide the running state using the steering torque instead of the SAT estimation value.

(4) In a control system for an electronic power steering that drives and controls a motor by feedback control, the control system includes:

a steering assist command value calculating portion for calculating and outputting a current command value of the motor, which applies a steering assisting force to a steering mechanism, based on a steering torque and a vehicle speed;

a SAT sensor for detecting a SAT of a vehicle; and

a motor current correction value calculating portion for deciding a running state of the vehicle based on a SAT value detected by the SAT sensor, the vehicle speed, and a steering angle, and correcting the current command value by calculating a motor current correction value based on the SAT value in accordance with the running state.

(5) In the control system according to (4), the motor current correction value calculating portion is configured to: decide a steering state by deciding a straight running state; and calculate the motor current correction value after a predetermined time elapsed in a case where the steering angle is equal to or less than a predetermined value 1, an absolute value of the SAT value is equal to or less than a predetermined value 2, and the vehicle speed is equal to or more than a predetermined value 3.

(6) In the control system according to (4), wherein the motor current correction value calculating portion is configured to: decide the running state using the steering torque instead of the SAT value.

### ADVANTAGES OF THE INVENTION

According to the control system for the electronic power steering of the present invention, the offset torque of the power steering unit can always be corrected precisely irrespective of the road surface situation generated depending on a vehicle factor, or the like or the driving condition such as the straight line running, or the like. Therefore, the comfortable high-performance electronic power steering capable of improving the steering feeling to have no influence on the steering operation can be provided.

In the present invention, the torque applied to the steering shaft (column shaft) during the straight line running is regarded as the offset torque, but such torque is not regarded as the offset torque in a situation that an input from the steering is balanced with a friction of the steering mechanism. Therefore, the correction torque can always be calculated precisely.

### BRIEF DESCRIPTION OF THE DRAWINGS

FIG. 1 is a block diagram showing an example of a configuration of a control system as a premise of the present invention.

FIG. 2 is a block diagram showing an example of a configuration of a SAT estimation feedback portion.

FIG. 3 is a view showing an example of the characteristic of a friction estimating portion.

FIG. 4 is a view showing an example of the characteristic of a speed sensitive gain.

FIG. 5 is a characteristic diagram showing a relationship between SAT based on a speed change and a steering angle.

FIG. 6 is a flowchart showing an example of an operation in sensing a steering center.

FIG. 7 is a flowchart showing an example of an operation in detecting a steering angle.

FIG. 8 is a flowchart showing an example of an operation of a motor current correction value calculating portion.

FIG. 9 is a characteristic diagram showing an example of a gain calculation map.

FIG. 10 is a block diagram showing an example of a configuration of a control system according to the present invention.

FIG. 11 is a flowchart showing an example of an operation of the present invention.

FIG. 12 is a view showing an example of a common configuration of an electronic power steering.

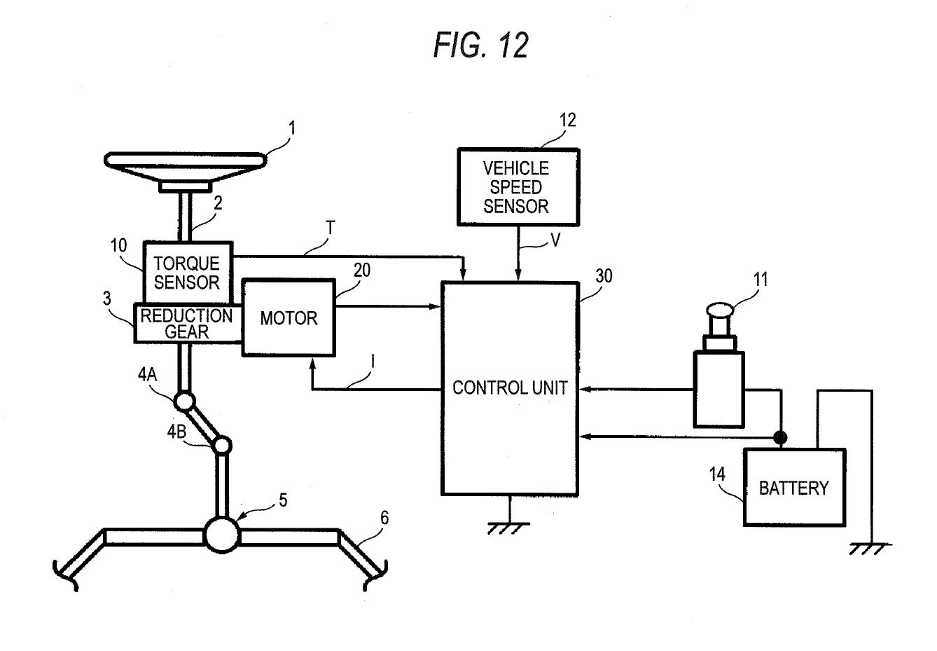

FIG. 13 a block diagram showing an example of a configuration of a control unit.

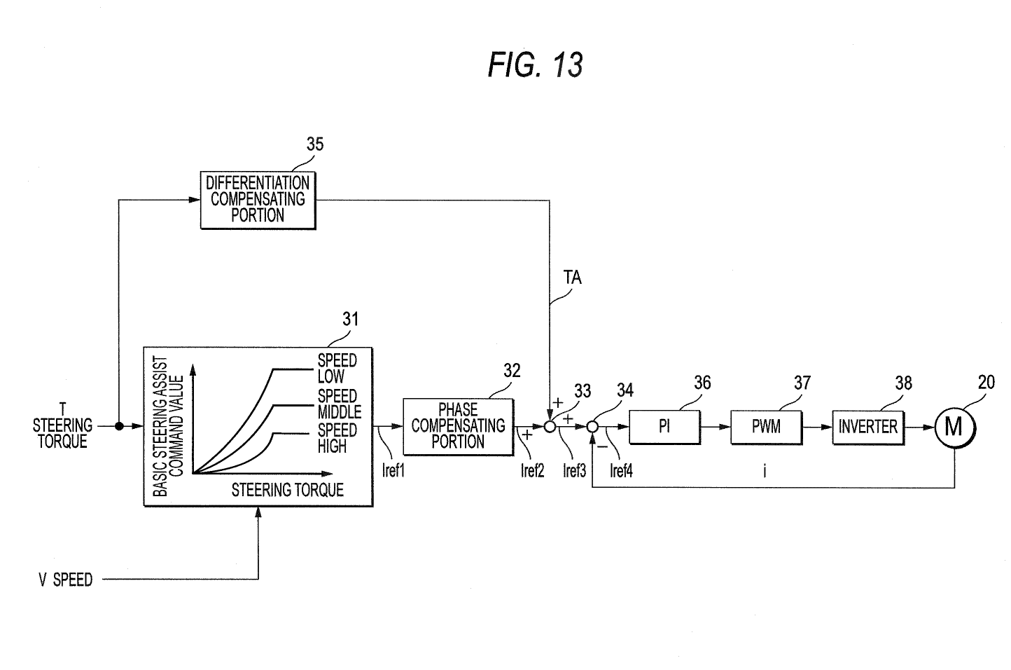

### DESCRIPTION OF REFERENCE NUMERALS AND SIGNS

1 steering wheel
2 column shaft
3 reduction gear
10, 40 torque sensor
12, 41 vehicle speed sensor
14 battery
20, 60 motor
30 control unit
31, 42 steering assist command value calculating portion
32 phase compensating portion
35, 43 differentiation compensating portion
36 PI controlling portion
37 PWM controlling portion
38 inverter
50 SAT estimation feedback portion
51 convergence controlling portion
52 robust stabilization compensating portion
61 motor driving portion
62 motor angular velocity estimating portion
63 motor angular acceleration estimating portion
64 motor characteristic compensating portion
70, 70A motor current correction value calculating portion

### BEST MODE FOR CARRYING OUT THE INVENTION

The steering torque being input from the road surface such as inclined road surface that is inclined in the road width direction, so-called split-μ road surface, or the like during the running or the input torque being generated when an air pressure in the tire is different between left and right wheels is applied to the steering system. In the prior art, when such torque is detected by the torque sensor, a differential gain of the feed forward system is set to 0, and thus such a situation is prevented that the assisting force is changed unsteadily (see Patent Literature 1). However, such a problem still exists that a constant torque input that is transferred continuously to the steering system from the road surface or the vehicle body side cannot be cancelled by this approach.

In order to solve the above problem, in the invention set forth in Patent Application No. 2005-262050 (referred to as a “prior application” hereinafter) according to this applicant, a torque applied to the column shaft during the straight line running of a vehicle is regarded as the offset, and a correction torque is calculated based on the offset torque. Then, the correction torque is converted into a current command value, and a correction is made gradually. Also, the offset torque generated during the straight line running is estimated in calculating the correction torque, and a correction is made directly on the current command value until the offset torque becomes 0. The present invention is made from the invention according to the prior application as the premise, and firstly the invention of the prior application will be explained hereunder.

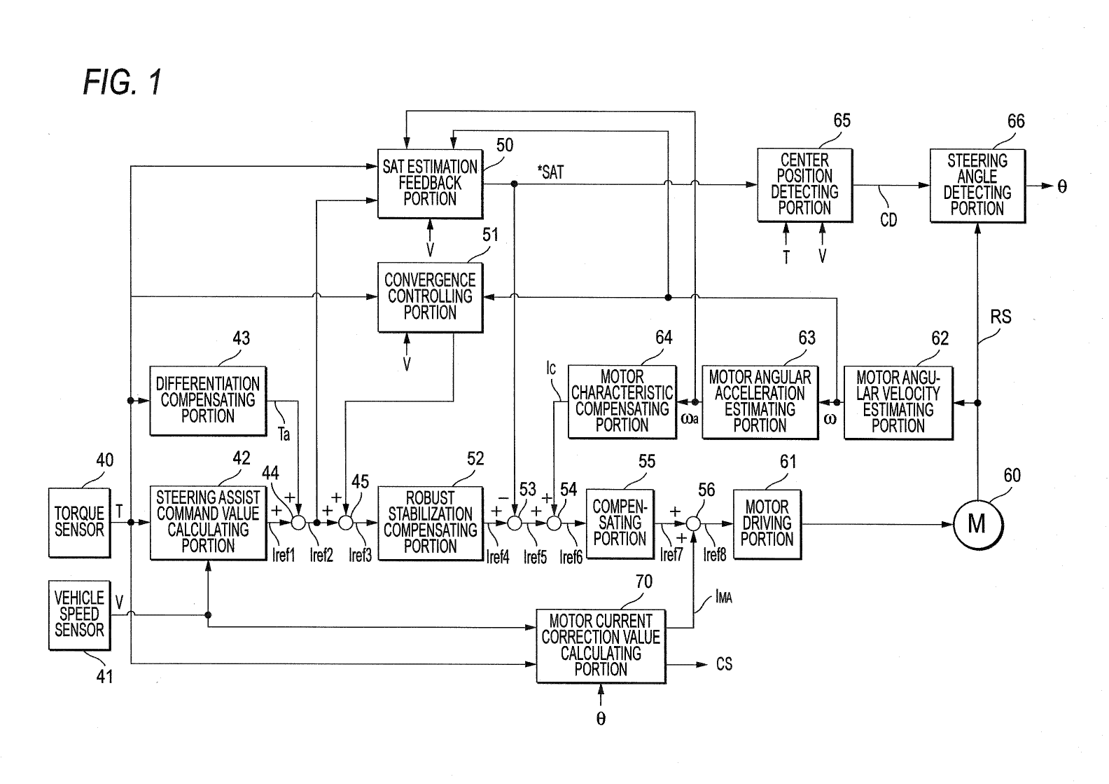

FIG. 1 shows an example of a configuration of the control system as the premise of the present invention. The steering torque T from a torque sensor 40 is input into a steering assist command value calculating portion 42, a differentiation compensating portion 43, a SAT estimation feedback portion 50, a convergence controlling portion 51, a center position detecting portion 65, and a motor current correction value calculating portion 70. The speed from a vehicle speed sensor 41 is input into the steering assist command value calculating portion 42, the SAT estimation feedback portion 50, the convergence controlling portion 51, the center position detecting portion 65, and the motor current correction value calculating portion 70. The steering assist command value Iref1 calculated by the steering assist command value calculating portion 42 is added to a differentiation compensation value Ta from the differentiation compensating portion 43 by an adding portion 44. The steering assist command value Ire2 as the added value is input into the SAT estimation feedback portion 50 and also input into an adding portion 45. A steering assist command value Iref3 as the added result of the adding portion 45 is input into a robust stabilization compensating portion 52. A steering assist command value Iref4 from the robust stabilization compensating portion 52 is input into an adding portion 53, and a current command value Iref5 as the added result is input into a compensating portion 55 via an adding portion 54. Then, a current command value Iref7 that is compensated by the compensating portion 55 is input into a motor driving portion 61 via an adding portion 56, and then a motor 60 is driven by the motor driving portion 61.

An angular velocity ω of the motor 60 is estimated by a motor angular velocity estimating portion 62, and the estimated angular velocity ω is input into a motor angular acceleration estimating portion 63 and the SAT estimation feedback portion 50. Then, an angular acceleration ωₐ estimated by the motor angular acceleration estimating portion 63 is input into a motor characteristic compensating portion 64 and the SAT estimation feedback portion 50. A SAT estimation value *SAT estimated by the SAT estimation feedback portion 50 is input into the center position detecting portion 65 and the adding portion 53. An output of the center position detecting portion 65 is input into a steering angle detecting portion 66, and the detected steering angle θ is input into the motor current correction value calculating portion 70. Also, a compensation value Ic from the motor characteristic compensating portion 64 is input into the adding portion 54, and a correction torque Tb from the motor current correction value calculating portion 70 is input into the adding portion 56.

The vehicle speed V input into the steering assist command value calculating portion 42 is obtained from a speed sensor or a Controller Area Network (CAN). The steering angle θ may be obtained from a steering angle sensor or a steering angle estimation, and the motor angular velocity ω may be obtained from a back electromotive force of the motor 60.

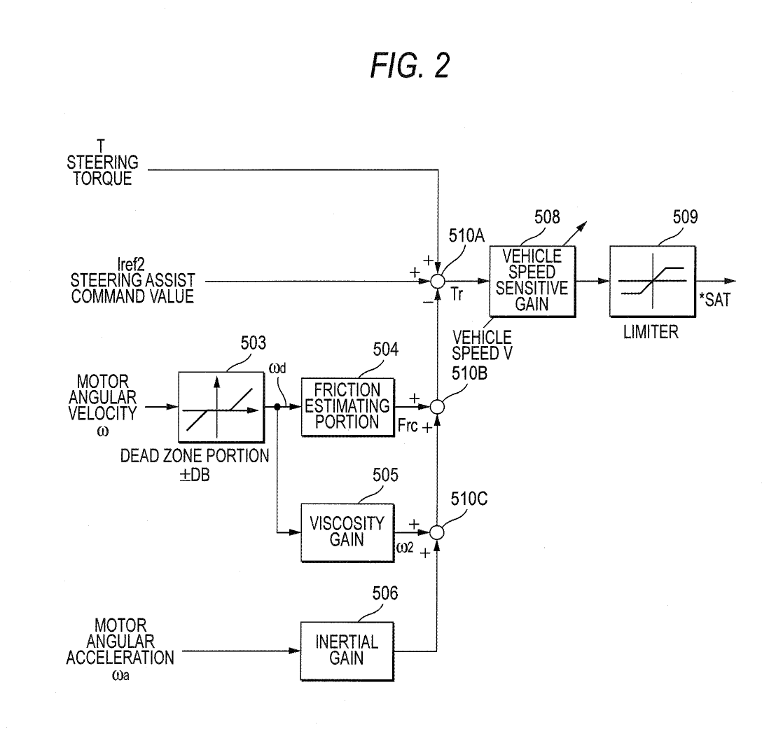

In order to improve a convergence of a yaw of the vehicle, the convergence controlling portion 51 applies a brake to a turning operation of the steering wheel based on the steering torque T and the motor angular velocity ω. In this example, this controlling operation is of a vehicle speed sensitive type. The differentiation compensating portion 43 is constructed to implement the smooth steering operation by enhancing a response of a control around a neutral point of the steering wheel. The SAT estimation feedback portion 50 performs signal-processing on the estimated SAT estimation value *SAT by using the feedback filter, and gives appropriate road surface information to the steering wheel as a reaction force. That is, the SAT estimation feedback portion 50 executes the signal processing to the mad surface information, disturbance, and the like in a frequency domain. This SAT estimation feedback portion 50 has a configuration shown in FIG. 2. The steering torque T is input into an adding/subtracting portion 510 to add, and the steering assist command value Ire2 is input into the adding/subtracting portion 510A to add. Also, the motor angular velocity ω is input into a friction estimating portion 504 and a viscosity gain 505 via a dead zone portion 503 having a dead zone width ±DB. A friction Frc from the friction estimating portion 504 is input into an adding portion 510B, and an angular velocity ω2 from the viscosity gain 505 is input into an adding portion 510C. The motor angular acceleration ωₐ is input into the adding portion 510C via an inertial gain 506, and the added result of the adding portion 510C is added to the friction Frc by the adding portion 510B. The added result is input into the adding/subtracting portion 510A to subtract. A torque command value Tr as the added/subtracted result of the adding/subtracting portion 510A acts as the SAT estimation value *SAT through a vehicle speed sensitive gain 508 and a limiter 509.

As the mode of the torque generated between the road surface and the steering wheel, the steering torque T is generated when the driver turns the steering wheel, and the motor 60 generates an assist torque Tm in accordance with the steering torque T. As a result, the wheels are steered, and SAT is generated as a reaction force. At that time, the torque is generated as a resistance of the steering operation by inertia J, viscosity k, and friction (static friction) Fr of the motor 60. From the balance of these forces, an equation of motion is given by following Equation 1.

J·ωₐ+k·ω+Fr·sign(ω)+SAT=Tm+T (1)

Here, following Equation 2 is given by applying the Laplace transform to Equation 1 at an initial value of zero and solving the result about SAT.

SAT(s)=Tm(s)+T(s)−(J·ωₐ(s)+Fr·sign(ω)(s))+k·ω) (2)

As can be seen from Equation 2, when the inertia J, the viscosity k, and the static friction Fr of the motor 60 are obtained in advance as a constant value respectively, the SAT can be estimated by the motor angular velocity ω, the motor angular acceleration ωₐ, the steering assist command value Ire2, and the steering torque T.

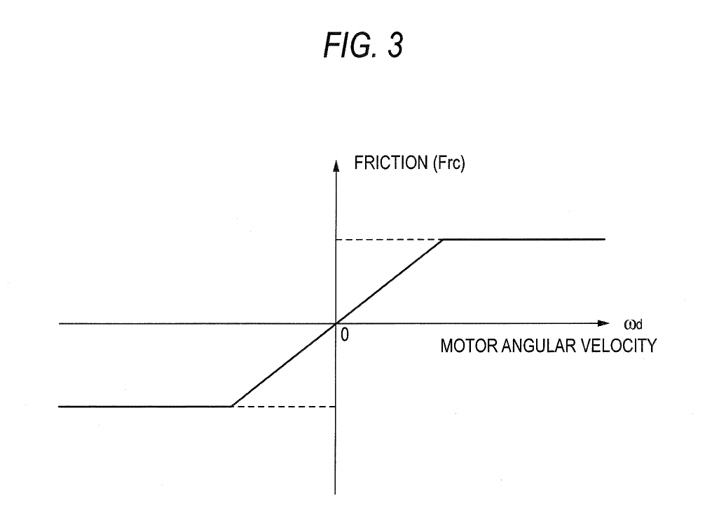

The dead zone portion 503 suppresses the characteristic around 0 of the motor angular velocity ω, and a motor angular velocity ωd as an output of the dead zone portion 503 is gain-controlled by the friction estimating portion 504 and the viscosity gain 505. The dead zone portion 503 is provided to remove the influence of minute variation of the motor angular velocity ω during holding the steering wheel. As shown in FIG. 3, the characteristic of the friction estimating portion 504 is increased gradually in a range in which the motor angular velocity ωd is small, and has a constant value in a range that exceeds a predetermined value. Here, a viscous friction is not considered, but only a Coulomb's friction is considered. Since a discontinuity occurs in the Coulomb's friction at a zero point, the Coulomb's friction is changed gradually along the motor angular velocity ωd to reduce the discontinuity, as shown in FIG. 3. In this case, the viscosity gain 505 of the viscosity as a reaction force generated by the speed has a constant value ω2.

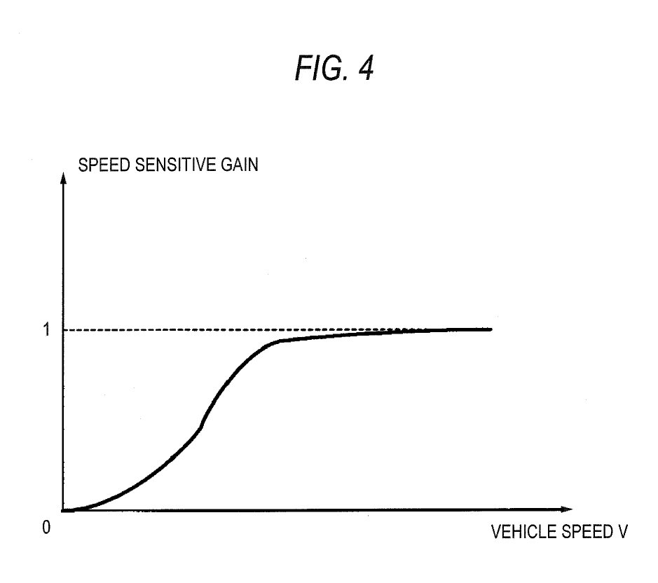

Also, the motor angular acceleration ωₐ is gain-controlled by the inertial gain 506 that is a constant value, and is input into the adding portion 510C. An output of the adding/subtracting portion 510A is gain-controlled by the vehicle speed sensitive gain 508 having the speed sensitive characteristic as shown in FIG. 4, and the SAT estimation value *SAT is output via the limiter 509 that limits a maximum value. The SAT estimation value *SAT estimated by the SAT estimation feedback portion 50 is input into the center position detecting portion 65 and is added to the current command value Iref4 by the adding portion 53.

The robust stabilization compensating portion 52 is a compensating portion disclosed in JP-A-8-290778. The robust stabilization compensating portion 52 removes a peak value of a resonance frequency of a resonance system consisting of an inertia element and a spring element contained in the detected torque, and compensates a phase displacement at the resonance frequency that disturbs a responsibility and a stability of the control system.

The center position detecting portion 65 detects a steering center position of the steering wheel in the straight line running state of the vehicle. When no friction is present in the steering system, the steering wheel returns to its center position by an action of SAT unless a steering force is applied after the steering wheel is turned. That is, the vehicle goes back to the straight line running state from the turning state, and the SAT becomes “0”. When the friction is considered, the SAT becomes “0” unless the steering force is applied, but the steering wheel is stopped due to the balance between the friction and the SAT. That is, the vehicle does not go back to the complete straight line running state from the turning state. A following Equation 3 is derived from Equation 2.

SAT(s)=−Fr·sign(ω(s)) (3)

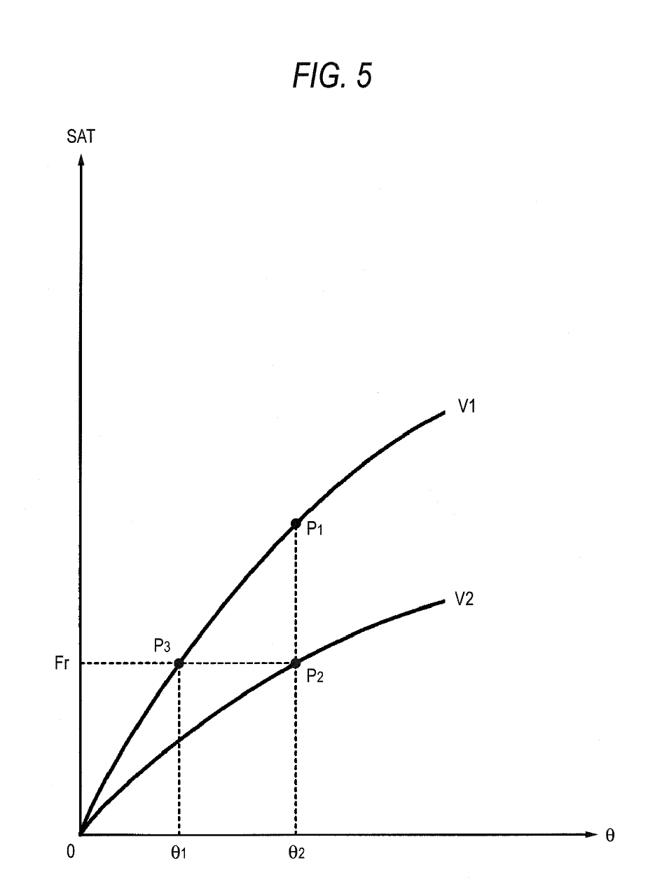

A relationship between the SAT based on the speed change and the steering angle is given as shown in FIG. 5. An angle θ2 of the steering wheel from the center depends on a magnitude of the friction Fr(=SAT) at the same speed V2, and a displaced angle increases as the friction increases. However, the SAT increases (P2→P1) at the same angle θ2 as the speed increases (V2→V1). As can be seen from P2→P3 in FIG. 5, the displaced angle of the steering wheel from the center decreases (θ1<θ2) when the speed increases (V1>V2) at the same friction Fr. Therefore, the center position sensing portion 65 detects an angle θ of the steering wheel as a steering center position (θ=0) when the steering torque T is less than a predetermined value T₀ and also the straight line running state (|SAT estimation value *SAT|≦SAT₀) is detected continuously for a predetermined time T₀ in a condition that the vehicle speed V is in excess of a predetermined speed V₀.

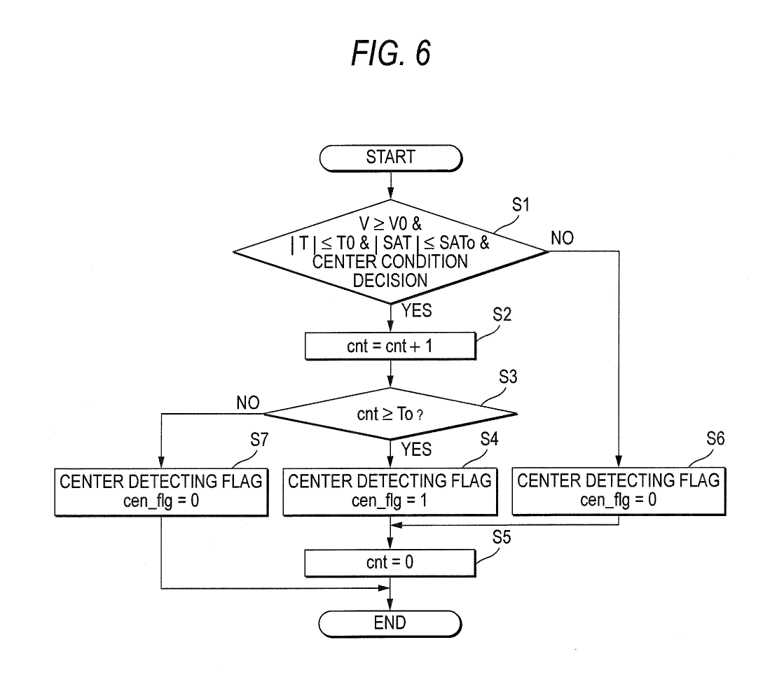

An example of the concrete detecting operation of a steering center position (θ=0) by the center position detecting portion 65 will be explained with reference to a flowchart in FIG. 6 hereunder.

Firstly, the vehicle speed V≧V₀, the steering torque |T|≦T₀, and the straight line running |SAT estimation value *SAT|≦SAT₀ by the SAT (thresholds used to decide the center conditions) are decided as the center conditions (step S1). If all conditions are satisfied, a time counter “cnt” for detecting the center is incremented by “+1” (step S2). Then, it is decided whether or not a count value of the time counter “cnt” exceeds a center detecting threshold T₀ (step S3). If the count value of the time counter “cnt” exceeds the center detecting threshold T₀, a center detecting flag “cen_flg=1” is set up (step S4). Then, the time counter “cnt” is reset (step S5). Then, the process is ended. If the count value of the time counter “cnt” is smaller than the center sensing threshold T₀, the center detecting flag “cen_flg” is reset (step S7). Then, the process is ended.

In contrast, if all conditions are not satisfied in step S1, the center detecting flag “cen_flg” is reset (step S6). Then, the time counter “cnt” is reset (step S5). Then, the process is ended. If the center detecting flag “cen_flg” is set up, a center detecting signal CS is output from the center position detecting portion 65 and is input into the steering angle detecting portion 66.

The steering angle detecting portion 66 detects the steering angle (absolute steering angle) θ based on a motor rotation angle signal RS from the sensor fitted to the motor 60. In this case, an amount of change in a motor rotation angle Δθm is obtained from the motor rotation angle signal RS. Also, an amount of change in the steering angle Δθ is derived as a function of the amount of change in the motor rotation angle Δθm by following Equation 4, depending on a reduction gear ratio Gr (constant) between the motor shaft and the column shaft.

Δθ=(1/Gr)×Δθm=f(Δθm) (4)

However, since a mechanical mechanism is present between the motor shaft and the column shaft, damper, backlash, spring characteristic, etc. must be considered. Also, the steering angle θ is calculated by accumulating an amount of change in the steering angle Δθ from the steering angle θ=0 according to following Equation 5.

θ(t)=θ(t−T)+Δθ(t) (5)

Here, θ(t−T) denotes a steering angle detected value prior to one sampling time, and the number of revolution N of the steering wheel is represented as a function that is indicated by a 360 degree multiple (cut off by floor) of θ (t) like a following Equation 6.

N=floor(θ(t)/360) (6)

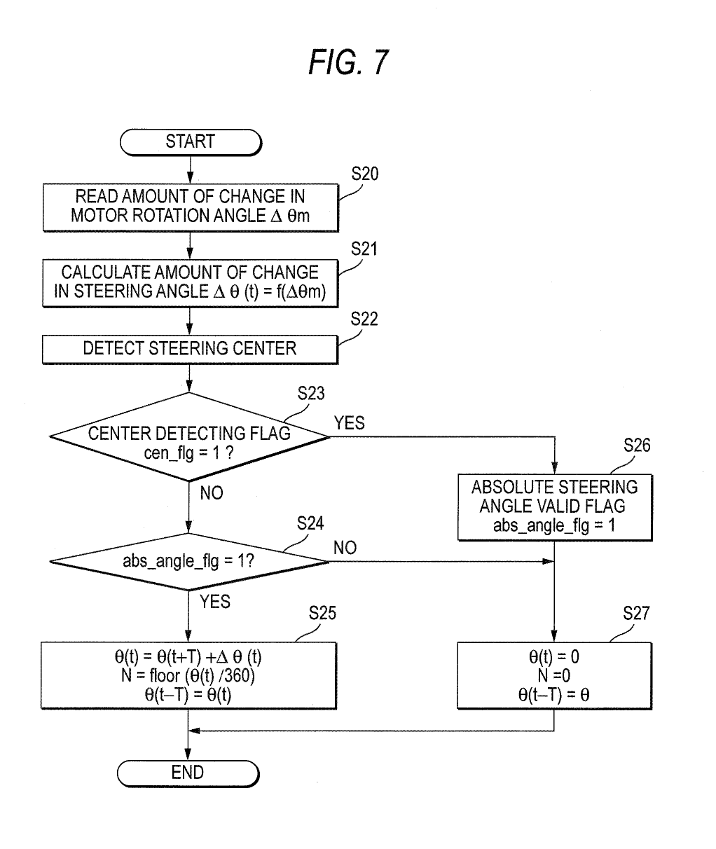

Next, a concrete example of the operation of the steering angle sensing portion 66 will be explained with reference to a flowchart in FIG. 7 hereunder.

Firstly, all parameters are initialized, and the amount of change in a motor rotation angle Δθm is read (step S20). Then, an amount of change in the steering angle Δθ(t)=f(Δθm) is calculated (step S21). Then, a steering center is detected by the steering center position detecting portion 66 (step S22). Then, it is decided whether or not a center detecting flag “cen_flg” is set up, i.e., the center detecting signal CS is input (step S23). If the center detecting signal CS is not input, it is decided whether or not an absolute steering angle valid flag “abs_angle_flg” is set up (step S24). If the absolute steering angle valid flag “abs_angle_flg” is set up, calculations are made based on the above Equations 5 and 6 and θ(t−T)=θ(t) is calculated (step S25). Then, the process is ended. Also, if the center detecting signal CS is input in step S23, the absolute steering angle valid flag “abs_angle_flg” is set up (step S26). Then, θ(t)=0, N=0, and θ(t−T)=0 are set (step S27). Then, the process is ended. Similarly, if the absolute steering angle valid flag “abs_angle_flg” is not set up in step S24, θ(t)=0, N=0, and θ(t−T)=0 are set (step S27). Then, the process is ended.

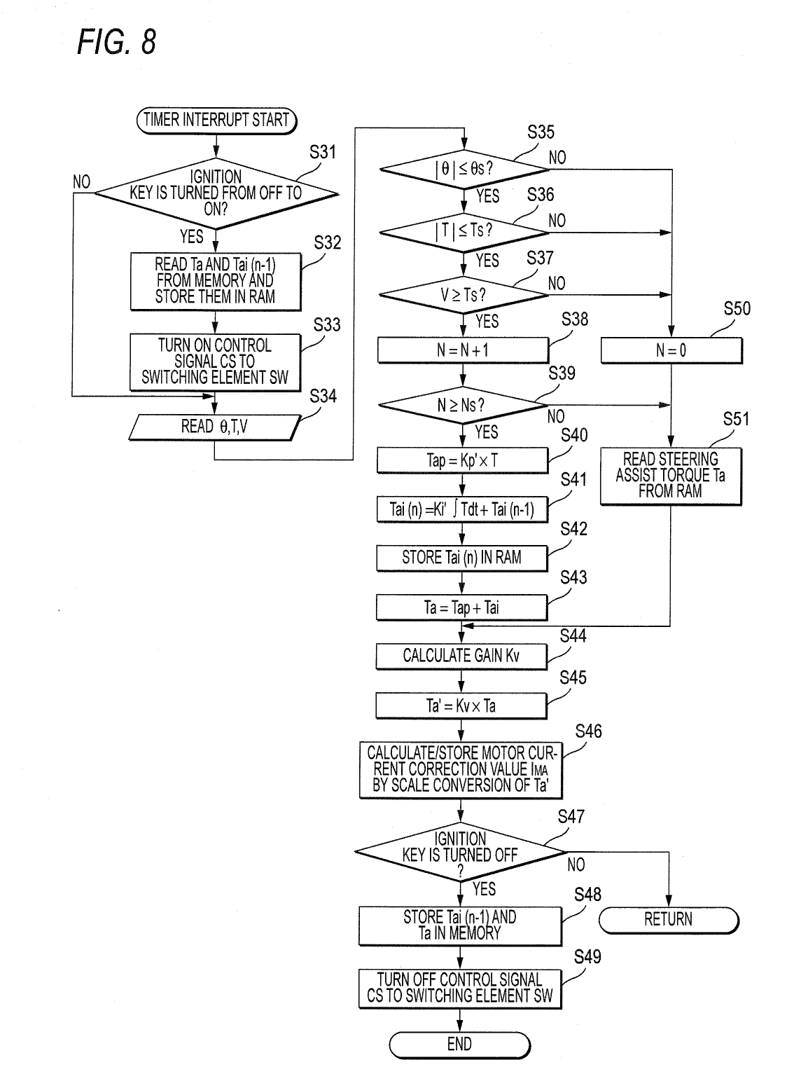

Next, an example of the operation of the motor current correction value calculating portion 70 will be explained with reference to a flowchart in FIG. 8 hereunder.

The calculation of the motor current correction value is executed as a timer interrupt process to a predetermined main program every predetermined time.

Firstly, it is decided whether or not an ignition key is turned from OFF to ON to turn ON a power supply (step S31). If the power supply is turned ON, a steering assist torque correction value integral component Tai(n−1) and a steering assist torque correction value Ta are read from a memory (e.g., EEPROM) and stored in an integral component memory area and a torque correction value memory area formed in the memory such as RAM, or the like (step S32). Then, a control signal CS to turn ON a switching element SW of a self-hold circuit is output (step S33). Then, the steering angle θ, the steering torque T, and the vehicle speed V are read (step S34). In contrast, if the power supply is not turned ON in step S31, the steering angle θ, the steering torque T, and the vehicle speed V are read directly.

Then, it is decided whether or not an absolute value |θ| of the steering angle θ is equal to or less than a predetermined value Ts that is set previously to decide the straight line running state of the vehicle (step S35). If the absolute value |θ| is equal to or less than the predetermined value θs, it is decided that such a possibility is high that the vehicle is in the straight line running state. Then, it is decided whether or not an absolute value T of the steering torque T is equal to or less than a predetermined value Ts that is set previously to decide the straight line running state of the vehicle (step S36). If the absolute value T is equal to or less than the predetermined value Ts, it is decided that such a possibility is high that the vehicle is in the straight line running state. Then, it is decided whether or not the vehicle speed V is equal to or more than a predetermined value Vs that is set previously to decide the straight line running state of the vehicle (step S37). Then, if the vehicle speed V is equal to or more than the predetermined value Vs, it is decided that such a possibility is high that the vehicle is in the straight line running state, and the subsequent process is executed.

Then, the count value N indicating a continued time of the straight line running state is incremented by “+1” (step S38). Then, it is decided whether or not the count value N is equal to or more than a set value Ns that is set previously (step S39). If the count value N is equal to or larger than the set value Ns, a calculation in following Equation 7 is carried out based on the present steering torque T, and thus a steering assist torque correction value proportional component Tap is calculated (step S40).

Tap=Kp′×T (7)

Then, a calculation in following Equation 8 is carried out based on the present steering torque T, and thus a steering assist torque correction value integral component Tai is calculated (step S41).

Tai(n)=Ki′·∫Tdt+Tai(n−1) (8)

Here, Tai(n−1) represents the steering assist torque correction value integral component in the preceding step as an integral initial value.

Then, the steering assist torque correction value integral component Tai(n) calculated here is stored in an integral component preceding value memory area formed as the steering assist torque correction value integral component Tai(n−1) in one preceding calculation, i.e., an integral initial value in the memory (step S42). Then, a steering assist torque correction value Ta is calculated by a following Equation 9, and is stored in the torque correction value memory area of the memory (step S43).

Ta=Tap+Tai (9)

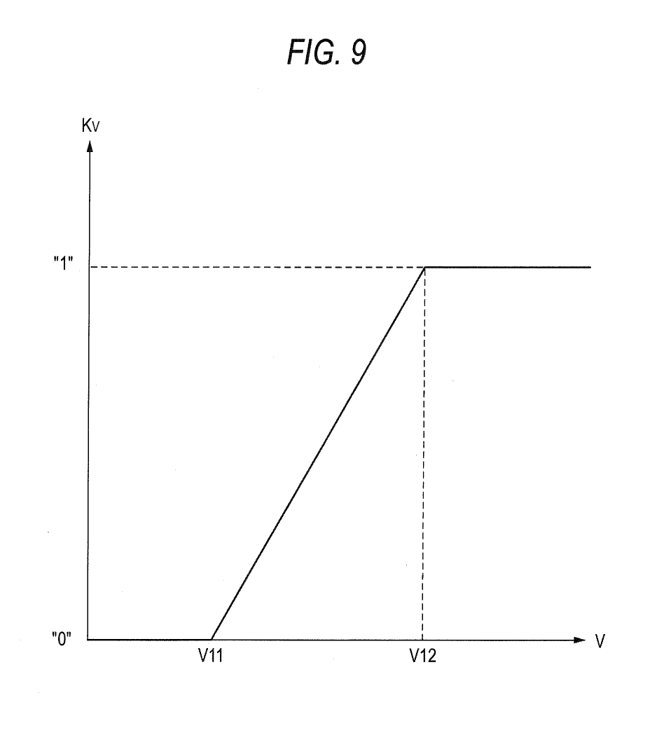

Then, a gain Kv is calculated by looking up a gain calculation map shown in FIG. 9 based on the vehicle speed V (step S44). Here, as shown in FIG. 9, the gain calculation map is set such that the gain Kv is set to 0 until the vehicle speed V reaches a first set value V11 from 0, the gain Kv is increased continuously from 0 to 1 in response to an increase of the vehicle speed V until the vehicle speed V reaches a second set value V12 from the first set value V11, and the gain Kv is kept at 1 when the vehicle speed V exceeds the second set value V12.

Then, a steering assist torque correction value Ta′ (=Kv×Ta) is calculated by multiplying the steering assist torque correction value Ta by the gain Kv (step S45). Then, a motor current correction value I_{MA} is calculated by converting the calculated steering assist torque correction value Ta′ into a current value corresponding to a motor current command value, and then stored in the motor current correction value memory area of the memory (step S46). Then, it is decided whether or not an ignition key is turned OFF (step S47). If the ignition key is in an ON state, the process returns to a main program. Then, if the ignition key is in an OFF state, the steering assist torque correction value integral component Tai(n−1) and the steering assist torque correction value Ta stored in the memory at that point of time are stored in the integral component memory area and the torque correction value memory area of the memory (step S48). It is decided that the control signal CS to the switching element SW of the self-hold circuit is in the OFF state, and the self holding is released (step S49). Then, the timer interrupt process is ended.

In contrast, if it is decided in step S35 that |θ|>θs, or if it is decided in step S36 that |T|>Ts, or if it is decided in step S37 that V<Vs, the count value N is reset to 0 (step S50). Then, the steering assist torque correction value Ta is read from the memory, and the process goes to above step S44 (step S51). Also, if it is decided in step S39 that N<Ns, the steering assist torque Ta is read from the memory, and the process goes to above step S44 (step S51).

As described above, when it is detected that the vehicle is in the straight line running state, the offset torque that is input into the steering system from the vehicle body side or the road surface side is detected by the offset torque detecting portion, a motor current value I_{MA} used to correct the motor current command value is calculated by the command value correcting portion based on the detected offset torque, and the motor current command value calculated by the driving controlling portion is corrected using the motor current value I_{MA}. Therefore, the steering assisting force is generated to cancel the offset torque that is input into the steering system from the road surface or the vehicle body side in the straight line running state when either the air pressure in the tire is different between left and right wheels or the vehicle travels on the road surface that is inclined in the road width direction or the split-μ road surface whose coefficient of friction is different between the left and right wheels, and the straight line stability of the vehicle can be ensured. In addition, when the steering assist torque correction value is stored in advance in a nonvolatile storing portion, the motor current command value can be corrected immediately after the vehicle starts the running and thus the running stability can be ensured.

However, the torque offset caused by factors except the steering system in the straight line running state is not taken into consideration. Further, when the torque applied to the column shaft in the straight line running state is regarded as the offset torque, such torque is also regarded as the offset torque even in a state that the input from the steering wheel is balanced with the friction of the steering mechanism. For this reason, it is feared that the wrong torque is calculated as the correction torque.

Therefore, in the present invention, the motor current correction value I_{MA} is calculated by using the SAT estimation value *SAT or the SAT detection value, i.e., by regarding the SAT as the offset torque. As a result, the steering function can be improved much more by calculating the more precise correction current command value.

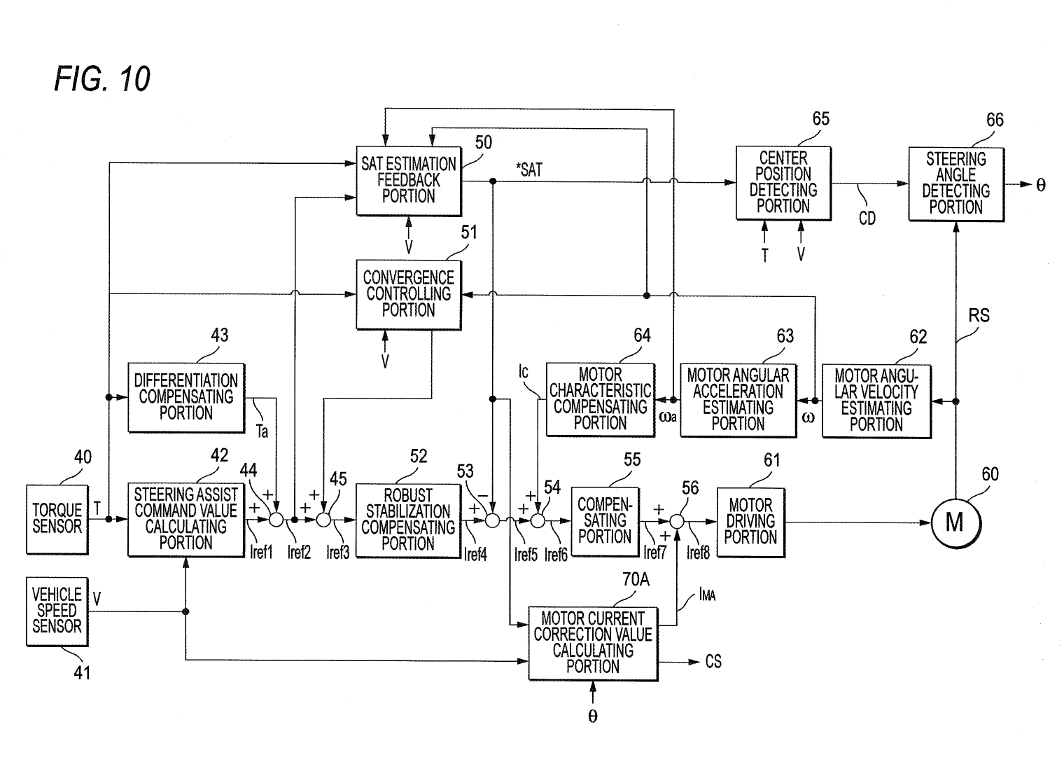

FIG. 10 shows an example of a configuration of the control system according to the present invention, which corresponds to FIG. 1. In the present invention, the SAT estimation value *SAT output from the SAT feedback estimating portion 50 is input into a motor current correction value calculating portion 70A, but the steering torque T is not input into the motor current correction value calculating portion 70A. Other configurations and operations are similar to those in FIG. 1.

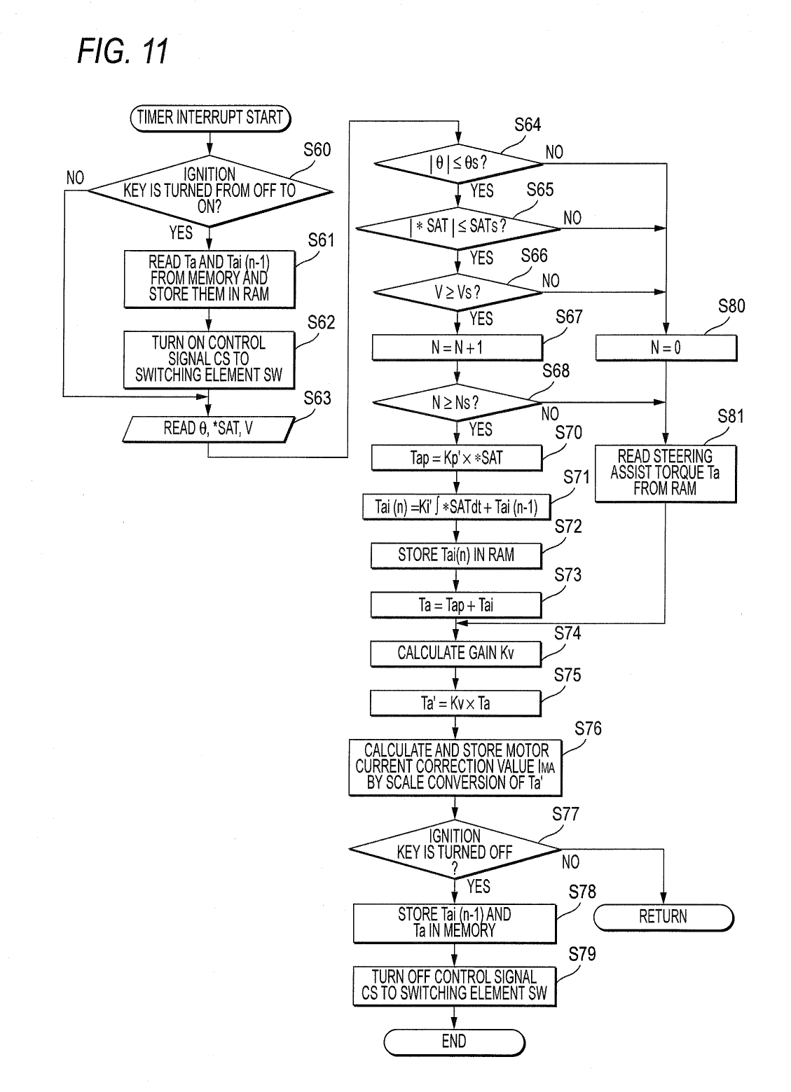

An example of an operation of the motor current correction value calculating portion 70A will be explained with reference to a flowchart in FIG. 11 hereunder.

Firstly, it is decided whether or not an ignition key is turned ON to turn ON a power supply (step S60). If the power supply is in its ON state, the steering assist torque correction value integral component Tai(n−1) and the steering assist torque correction value Ta stored in a memory are read from the memory, and then store them in the memory (step S61). Then, the control signal CS to turn ON the switching element SW of the self-hold circuit is output (step S62). Then, the steering angle θ, the SAT estimation value *SAT, and the vehicle speed V are read (step S63). In contrast, if the power supply is not in its ON state in step S60, the steering angle θ, the SAT estimation value *SAT, and the vehicle speed V are read directly.

Then, it is decided whether or not an absolute value |θ| of the steering angle θ is equal to or less than a predetermined value θs that is set previously to decide the straight line running state of the vehicle (step S64). If the absolute value |θ| is equal to or less than the predetermined value θs, it is decided that such a possibility is high that the vehicle is in the straight line running state. Then, it is decided whether or not an absolute value |*SAT| of the SAT estimation value *SAT is equal to or less than a predetermined value SATs that is set previously to decide the straight line running state of the vehicle (step S65). If the absolute value |*SAT| is equal to or less than the predetermined value *SATs, it is decided that such a possibility is high that the vehicle is in the straight line running state. Then, it is decided whether or not the vehicle speed V is equal to or more than a predetermined value Vs that is set previously to decide the straight line running state of the vehicle (step S66). Then, if the vehicle speed V is equal to or more than the predetermined value Vs, it is decided that such a possibility is high that the vehicle is in the straight line running state, and the subsequent process is executed.

Then, the count value N indicating a continued time of the straight line running state is incremented by “+1” (step S67). Then, it is decided whether or not the count value N is equal to or more than a set value Ns (step S68). If the count value N is smaller than the set value Ns, a calculation in following Equation 10 is carried out based on the present SAT estimation value *SAT, and thus a steering assist torque correction value proportional component Tap is calculated (step S70).

Tap=Kp′×*SAT (10)

Then, an integrating calculation in following Equation 11 is carried out based on the present SAT estimation value *SAT, and thus the steering assist torque correction value integral component Tai(n) is calculated (step S71).

Tai(n)=Ki′·∫*SATdt+Tai(n−1) (11)

Then, the calculated steering assist torque correction value integral component Tai(n) is stored in the memory as the integral initial value (step S72). Then, the steering assist torque correction value Ta is calculated by above Equation 9, and is stored in the memory (step S73). Then, like the above, the gain Kv is calculated based on the vehicle speed V (step S74).

Then, the steering assist torque correction value Ta′ is calculated by multiplying the calculated steering assist torque correction value Ta by the gain Kv (step S75). Then, the motor current correction value I_{MA} is calculated by converting the calculated steering assist torque correction value Ta′ into a current value, and then stored in the memory (step S76). Then, it is decided whether or not the ignition key is turned OFF (step S77). If the ignition key is in its ON state, the process is returned. If the ignition key is in its OFF state, the steering assist torque correction value integral component Tai(n−1) and the steering assist torque correction value Ta at that point of time are stored in the memory (step S78). Then, it is decided that the control signal CS to the switching element SW of the self-hold circuit is in the OFF state, and the self holding is released (step S79). Then, the timer interrupt process is ended.

In contrast, if it is decided in step S64 that |θ|>θs, or if it is decided in step S65 that |*SAT|>SATs, or if it is decided in step S66 that V<Vs, the count value N is reset to 0 (step S80). Then, the steering assist torque is read from the memory, and the process goes to above step S74 (step S81). Also, if it is decided in step S68 that N<Ns, the steering assist torque is read from the memory (step S81), and the process goes to above step S74.

As described above, according to the present invention, the steering input and the offset input can be separated by estimating the offset torque generated by a vehicle factor, or the like by virtue of the SAT. As a result, only the offset torque generated by an external force can be corrected.

In the above explanation, the SAT estimation value *SAT is utilized in deciding the straight line running of the vehicle (the steering angle θ, the SAT estimation value *SAT, and the vehicle speed V). But the straight line running of the vehicle may be decided by the steering torque T (the steering angle θ, the steering torque T, and the vehicle speed V). Also, in the above explanation, the SAT is estimated by the SAT estimation feedback portion, but the SAT detected value detected by the SAT sensor can be employed.

The present application is based upon Japanese Patent Application No. 2006-129331, filed on May 8, 2006, the contents of which are incorporated herein by reference.

1. A control system for an electronic power steering that drives and controls a motor by feedback control, the control system comprising:
a steering assist command value calculating portion for calculating and outputting a current command value of the motor, which applies a steering assisting force to a steering mechanism, based on a steering torque and a vehicle speed;
a SAT estimating portion for estimating a self aligning torque (SAT) of a vehicle by inputting an angular velocity and an angular acceleration of the motor, the steering torque, and the current command value; and
a motor current correction value calculating portion for deciding a running state of the vehicle based on a SAT estimation value estimated by the SAT estimating portion, the vehicle speed, and a steering angle, and correcting the current command value by calculating a motor current correction value based on the SAT estimation value in accordance with the running state.

2. The control system according to claim 1, wherein
the motor current correction value calculating portion is configured to:
decide a steering state by deciding a straight running state; and
calculate the motor current correction value after a predetermined time elapsed in a case where the steering angle is equal to or less than a predetermined value 1, an absolute value of the SAT estimation value is equal to or less than a predetermined value 2, and the vehicle speed is equal to or more than a predetermined value 3.

3. The control system according to claim 1, wherein the motor current correction value calculating portion is configured to:
decide the running state using the steering torque instead of the SAT estimation value.

4. A control system for an electronic power steering that drives and controls a motor by feedback control, the control system comprising:
a steering assist command value calculating portion for calculating and outputting a current command value of the motor, which applies a steering assisting force to a steering mechanism, based on a steering torque and a vehicle speed;
a SAT sensor for detecting a self aligning torque (SAT) of a vehicle; and
a motor current correction value calculating portion for deciding a running state of the vehicle based on a SAT value detected by the SAT sensor, the vehicle speed, and a steering angle, and correcting the current command value by calculating a motor current correction value based on the SAT value in accordance with the running state.

5. The control system according to claim 4, wherein the motor current correction value calculating portion is configured to:
decide a steering state by deciding a straight running state; and
calculate the motor current correction value after a predetermined time elapsed in a case where the steering angle is equal to or less than a predetermined value 1, an absolute value of the SAT value is equal to or less than a predetermined value 2, and the vehicle speed is equal to or more than a predetermined value 3.

6. The control system according to claim 4, wherein the motor current correction value calculating portion is configured to:
decide the running state using the steering torque instead of the SAT value.
